(19) United States
(12) Patent Application Publication
(10) Pub. No.: US 2013/0003057 A1
(43) Pub. Date: Jan. 3, 2013

(54) Fluid Separation Device, Gas Separation Device and Detection Device Using the Same

(75) Inventor: Tetsuo MANO, Chino (JP)

(73) Assignee: SEIKO EPSON CORPORATION, Tokyo (JP)

(21) Appl. No.: 13/538,329

(22) Filed: Jun. 29, 2012

(30) Foreign Application Priority Data
Jul. 1, 2011 (JP) 2011-147094

(51) Int. Cl. G01N 1/44; G01J 3/44

(52) U.S. Cl. 356/301; 73/863.21

(57) ABSTRACT

A fluid separation device includes a holding member which holds a first fluid sample and a light source which casts light with a specific wavelength onto the holding member. When the first fluid sample contains a specific substance, a maximum value L1 of absorptivity at which the specific substance absorbs the light with the specific wavelength and an absorptivity L2 at which another substance in the first fluid sample than the specific substance absorbs the light with the specific wavelength satisfy L1>L2, and an absorptivity L3 at which the holding member absorbs the light with the specific wavelength satisfies L3<L1.

### BACKGROUND

1. Technical Field

The present invention relates to a fluid separation device, a gas separation device and a detection device or the like using the same.

2. Related Art

Recently, there is increasing demand for sensors used for medical diagnosis, inspection of food and drink and the like and development of a technique for providing a sensor capable of sensing with a small size and high sensitivity is desired. Particularly in the field of detecting a gas, measuring methods such as a measuring method using a semiconductor sensor, a crystal oscillator microbalance measuring method, and a measuring method using a sensor utilizing surface Plasmon resonance are proposed.

In these measuring methods, a detection substance is detected based on a change in electrical, mechanical and optical characteristics due to attachment of the detection substance to a measuring unit. However, a particular change may be generated by other substances than the detection target. Therefore, it is difficult to detect a specific substance from a gas mixture containing plural substances and the detection substance needs to be separated from the gas mixture. Meanwhile, a measuring method that can identify a substance such as Raman spectroscopy is used. In this measuring method, when a substance is irradiated with excitation light, scattered light (Raman-scattered light) in which a wavelength corresponding to molecular vibrational energy of the substance is shifted is spectroscopically detected from the excitation light and a molecular fingerprint spectrum is obtained. Since the shape of the molecular fingerprint spectrum is proper to each substance, the measuring target substance can be identified. However, in measuring a mixture, the fingerprint spectra are superimposed and therefore are very hard to analyze.

Thus, a device which separates a specific gas from the gas mixture before performing such measurement is required.

A technique for separating a specific fluid from a fluid mixture uses a separation film (JP-T-2003-530999).

According to the technique of JP-T-2003-530999, a porous adsorbent with a fluid mixture adsorbed thereto is heated and the separation film in contact with the adsorbent transmits a specific substance in the fluid mixture, thus separating the specific substance from the fluid mixture.

However, as the material used for the separation film, a material which selectively transmits a specific substance needs to be selected appropriately. Also, depending on the type of the substance to be detected, an appropriate separation film may not be secured.

### SUMMARY

An advantage of some aspect of the invention is that a fluid separation device and a gas separation device which can separate a specific fluid from a fluid sample or a specific gas from a gas sample without using a separation film, and a detection device using the same, are provided.

(1) An aspect of the invention is directed to a fluid separation device including: a holding member which holds a first fluid sample; and a light source which casts light with a specific wavelength onto the holding member. When the first fluid sample contains a specific substance, an absorptivity L1 at which the specific substance absorbs the light with the specific wavelength and an absorptivity L2 at which another substance in the first fluid sample than the specific substance absorbs the light with the specific wavelength satisfy L1>L2, and an absorptivity L3 at which the holding member absorbs the light with the specific wavelength satisfies L3<L1.

According to this aspect, as light with a specific wavelength is cast from the light source onto the holding member on which the first fluid sample is held, when the first fluid sample contains a specific substance, the specific substance mainly absorbs light energy and therefore the specific substance is desorbed from the holding member when such is chosen. Another substance than the specific substance in the first fluid sample absorbs less light energy than the specific substance. Moreover, the holding member, too, absorbs less light energy than the specific substance. Therefore, the another substance than the specific substance in the first fluid sample is less often provided with energy via the holding member. Thus, the concentration or partial pressure of the specific substance can be increased so that the specific substance can be separated from the first fluid sample.

(2) In one embodiment, L1-L2≧60% and L1-L3≧60% may hold. By setting the difference in absorptivity to the light with the specific wavelength as described above, accuracy with which the specific substance is separated from the first fluid sample can be improved.
(3) In one embodiment, the light source can have a variable emission wavelength. Thus, light with specific wavelengths proper to various specific substances can be cast thereon and versatility can be improved.
(4) In one embodiment, the fluid separation device can further include: a casing in which the holding member is accommodated; an introduction port provided on the casing; an exhaust port provided on the casing; a channel connected to the casing; a fan provided at least at one of the introduction port and the exhaust port; and an open-close valve provided in each of the introduction port, the exhaust port and the channel.

In this way, as the fan is driven in the state where the introduction port and the exhaust port are opened and where the channel is closed, the first fluid sample can be introduced into the casing. Next, as the driving of the fan is stopped and both the introduction port and the exhaust port are closed, the first fluid sample can be held on the holding member. Subsequently, as the light with the specific wavelength is cast onto the holding member from the light source, the specific substance can be separated from the first fluid sample.

(5) Another aspect of the invention is directed to a detection device including: the fluid separation device according to any of (1) to (4) in which the first fluid sample is introduced and in which when the first fluid sample contains the specific substance, the specific substance is separated from the first fluid sample and a second fluid sample with an increased concentration of the specific substance is generated; and a detection unit which detects the specific substance from the second fluid sample when the second fluid sample contains the specific substance.

According to this aspect, by connecting the fluid separation device and the detection unit, the second fluid sample with the increased concentration of the specific substance can be guided to the detection unit and detection accuracy at the detection unit can be improved.

(6) Still another aspect of the invention is directed to a gas separation device including: an adsorbent which adsorbs a first gas sample; and a light source which casts light with a specific wavelength onto the adsorbent. When the first gas sample contains a specific substance, the light with the specific wavelength is cast onto the adsorbent from the light source, thereby raising a partial pressure of the specific substance in a second gas sample desorbed from the adsorbent above a partial pressure of the specific substance in the first gas sample.

According to this aspect, the adsorbent is used as a holding member and the first gas sample is adsorbed to the adsorbent. The light with the specific wavelength is cast onto the adsorbent. Thus, the specific substance can be selectively desorbed from the adsorbent.

(7) Yet another aspect of the invention is directed to a detection device including: the gas separation device according to (6) in which in which the first gas sample is introduced and in which when the first gas sample contains the specific substance, the specific substance is separated from the first gas sample and the second gas sample with an increased partial pressure of the specific substance is generated; and a detection unit which detects the specific substance from the second gas sample when the second gas sample contains the specific substance. According to this aspect, by connecting the gas separation device and the detection unit, the second gas sample with the increased partial pressure of the specific substance can be guided to the detection unit and detection accuracy at the detection unit can be improved.
(8) Still yet another aspect of the invention is directed to a detection device including: a fluid separation device in which a first fluid sample is introduced and in which when the first fluid sample contains a specific substance, the specific substance is separated from the first fluid sample and a second fluid sample with an increased concentration of the specific substance is generated; and a detection unit which detects the specific substance from the second fluid sample when the second fluid sample contains the specific substance. The fluid separation device includes a holding member which holds the first fluid sample, and a light source which has a variable emission wavelength and casts light with a wavelength which causes the specific substance to be desorbed from the holding member onto the holding member.

According to this aspect, the emission wavelength from the light source can be varied to a wavelength proper to the specific substance according to the type of the specific substance. Therefore, highly accurate detection by the detection unit can be applied to plural specific substances and versatility can be improved.

### BRIEF DESCRIPTION OF THE DRAWINGS

The invention will be described with reference to the accompanying drawings, wherein like numbers reference like elements.

FIG. 1 is a block diagram of a detection device according to an embodiment of the invention.

FIG. 2 is a graph showing the infrared absorption spectrum of acetone as a separation target substance in a first fluid sample.

FIG. 3 is a graph showing the infrared absorption spectrum of ethanol as another substance than the separation target substance in the first fluid sample.

FIG. 4 is a graph showing the infrared absorption spectrum of water as another substance than the separation target substance in the first fluid sample.

FIG. 5 is a graph showing the infrared absorption spectrum of aluminum silicate as a holding member.

FIG. 6 shows an example of a light source which emits light with a specific wavelength.

FIG. 7 shows a Fabry-Perot filter used for the light source of FIG. 6.

FIG. 8 shows the transmission characteristic of the filter shown in FIG. 7.

FIG. 9 shows an attachment structure of the holding member.

FIG. 10A is an enlarged sectional view of a suction unit and an optical device. FIGS. 10B and 10C are sectional and plan views showing formation of an enhanced electric field at the optical device.

FIG. 11 is a graph showing a Raman shift of acetone.

FIG. 12 is a block diagram showing the outline of a detection unit.

FIG. 13 is a schematic explanatory view of an optical device used for surface enhanced infrared spectroscopy.

FIG. 14 is a graph showing infrared rays incident on the optical device of FIG. 13.

FIG. 15 is a graph showing infrared rays reflected by the optical device of FIG. 13.

### DESCRIPTION OF EXEMPLARY EMBODIMENTS

Hereinafter, a preferred embodiment of the invention will be described. The following embodiment should not unduly limit the content of the invention described in the accompanying claims. Not all parts of the configurations described in the embodiment are essential as measures for resolution according to the invention.

### 1. Basic Configuration of Detection Device

Hereinafter, an embodiment of the invention will be described, using a detection device which includes a fluid separation device for preprocessing and a detection unit.

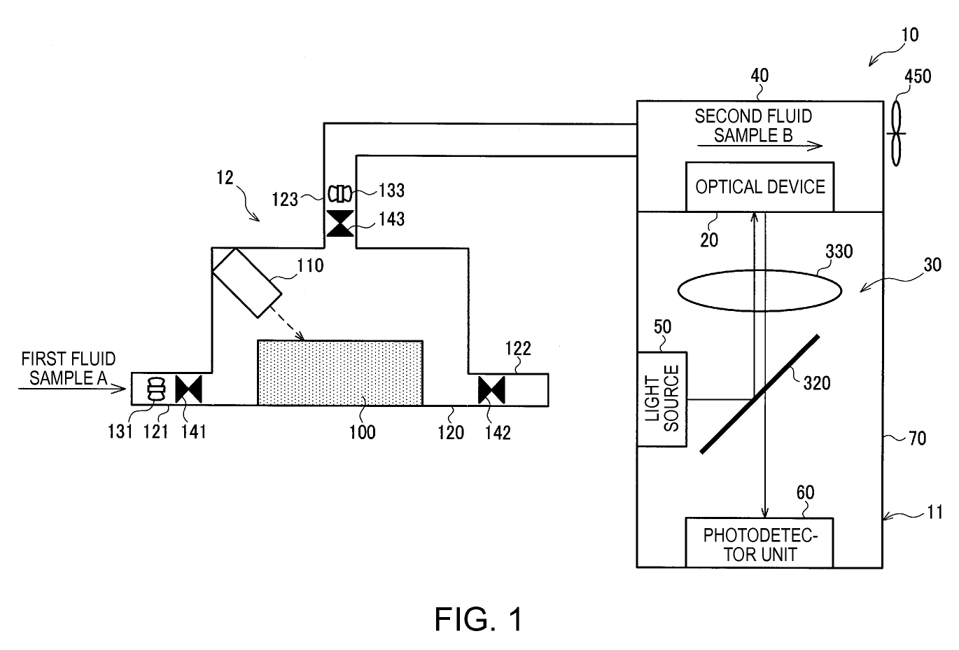

FIG. 1 shows an example of the configuration of the detection device according to this embodiment. In FIG. 1, a detection device 10 includes a detection unit 11 and a fluid (gas) separation device 12 functioning as a preprocessing unit of the detection unit 11. In the fluid separation device 12, a first fluid sample A which is a mixture of plural kinds of liquids (for example, water, water vapor and the like) and gases (for example, acetone, ethanol and the like) is introduced. The fluid separation device 12 separates a specific substance (sample molecule, separation target substance) from the first fluid sample A and generates a second fluid sample B with a higher concentration or partial pressure of the sample molecule than the first fluid sample. This second fluid sample B is led to the detection unit 11 by the fluid separation device 12.

The detection unit 11 includes, for example, an optical device 20, a suction unit 40, a light source 50 and a photodetector unit 60, inside a casing 70. An optical system 30 can be provided between the optical device 20 and the light source 50 and/or the photodetector unit 60. The optical device 20 is irradiated with light from the light source 50 and thus emits light that reflects, for example, the specific substance (sample molecule, separation target substance) in the fluid sample contacting the optical device 20.

The suction unit 40 sucks the second fluid sample B to the optical device 20, for example, using an exhaust fan 450. The light source 50 casts light onto the optical device 20, for example, via a half mirror 320 and an objective lens 330 constituting the optical system 30. The photodetector unit 60 detects the light reflecting the specific substance (sample molecule, separation target substance) held on the optical device 20, via the half mirror 320 and the objective lens 330. The detection unit 11 will be described in detail later.

### 2. Fluid Separation Device

### 2.1. Outline of Fluid Separation Device

The fluid separation device 12 will be described with reference to FIG. 1. The fluid separation device 12 includes a holding member 100 which holds the first fluid sample A, and a light source 110 which casts light onto the holding member 100. Specifically, a chamber (casing) 120 in which at least the holding member 100 is arranged is provided. The light source 110 may be provided inside the chamber 120, but not limited to this. Light from the light source 110 provided outside the chamber 120 may be introduced into the chamber 120 via a window made of a material that is transparent to the emission wavelength of the light source 110.

The chamber 120 is provided with an introduction port 121 through which the first fluid sample A is introduced into the chamber 120, an exhaust port 122 through which the fluid retained in the chamber 120 is exhausted, and a channel 123 through which the second fluid sample B desorbed from the holding member 100 is fed to the detection unit 11. On the side of the introduction port 121, an introduction fan 131 which feeds the first fluid sample A into the chamber 120, and an introduction valve 141 which opens and closes the introduction port 121 are provided. On the side of the exhaust port 122, an exhaust valve 142 which opens and closes the exhaust port 122 is provided. In the channel 123, a channel fan 133 which feeds the second fluid sample B to the detection unit 11, and a channel valve 143 which opens and closes the channel 123 are provided. Instead of the introduction fan 131, an exhaust fan may be provided at the exhaust port 122. The channel fan 133 may be eliminated. This is because the exhaust fan 450 of the detection unit 11 can feed the fluid sample in the fluid separation device 12 to the detection unit 11.

First, the channel valve 143 is closed and the introduction valve 141 and the exhaust valve 142 are opened. The introduction fan 131 is driven. Thus, the first fluid sample A is introduced into the chamber 120 from the introduction port 121. Subsequently, the introduction valve 141 and the exhaust valve 142 are closed.

As the holding member 100 arranged in the chamber 120, for example, a porous adsorbent can be suitably used, as will be described later, and can adsorb the first fluid sample A introduced into the chamber 120.

The light source 110 casts light in a specific wavelength range, particularly light in infrared range, onto the holding member 100. The light in the specific wavelength range is light having a wavelength with a high absorptivity to the specific substance (sample molecule, separation target substance) in the first fluid sample A held on the holding member 100. Also, the light in the specific wavelength range has a low absorptivity to the holding member 100 and the other fluids than the specific substance (sample molecule, separation target substance) in the first fluid sample A. Therefore, energy is provided efficiently to the sample molecule held on the holding member 100 and the sample molecule is desorbed from the holding member 100. By the desorption of the sample molecule, the second fluid sample B with a high concentration or partial pressure of the specific substance (sample molecule, separation target substance) is generated in the chamber 120.

Afterwards, the channel valve 143 is opened and the channel fan 133 is driven. Thus, the second fluid sample B with the increased concentration or partial pressure of the sample molecule that is desorbed is fed to the detection unit 11 via the channel 123.

### 2.2. Principle of Fluid Separation

Atoms constituting a molecule constantly repeat vibrating according to the mass thereof, relative positions to each other, the strength of bond and the like. This causes a shift of the center of gravity and rotation of the whole molecule. Of such vibrations, a vibration that may change the dipole moment causes electromagnetic waves and the molecule to interact with each other. The light source 110 casts light in a specific wavelength range, particularly infrared rays, onto the molecule having such vibration. Thus, when the period of vibration of the infrared rays and the period of vibration of the atoms do not coincide with each other, the infrared rays are transmitted without being absorbed by the molecule. On the other hand, when the period of vibration of the infrared rays and the period of vibration of the atoms coincide with each other, the infrared rays are absorbed by the molecule and the vibration changes from the ground state to the excitation state. Therefore, depending on the molecular structure of the substance, different wavelengths of infrared rays are absorbed.

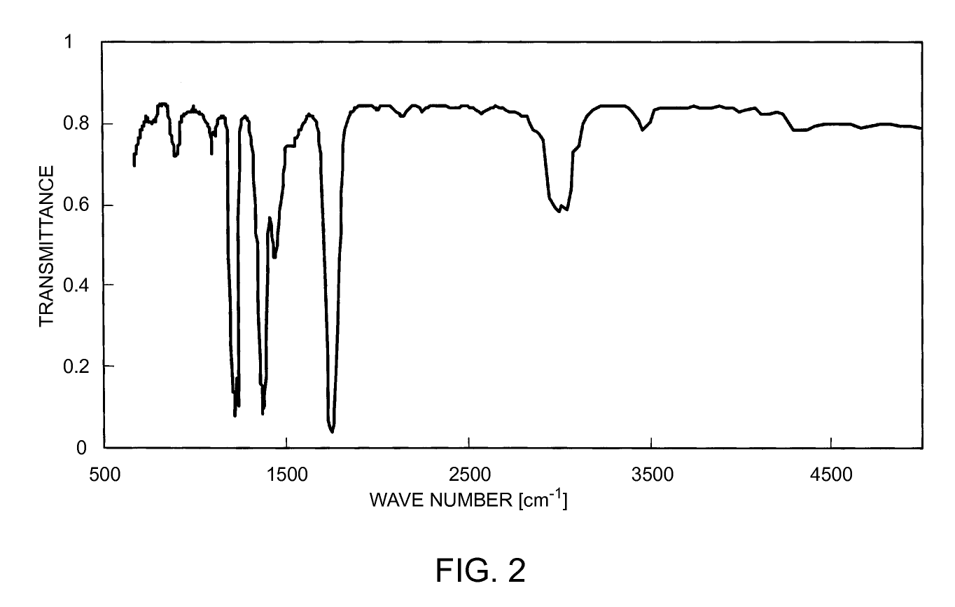

FIG. 2 is a graph showing the infrared absorption spectrum of acetone (CH3-CO-CH3). The horizontal axis represents wave number (cm⁻¹). The vertical axis represents transmittance. As shown in FIG. 2, acetone has a characteristic absorption peak due to C=0 group at 1742 cm⁻¹.

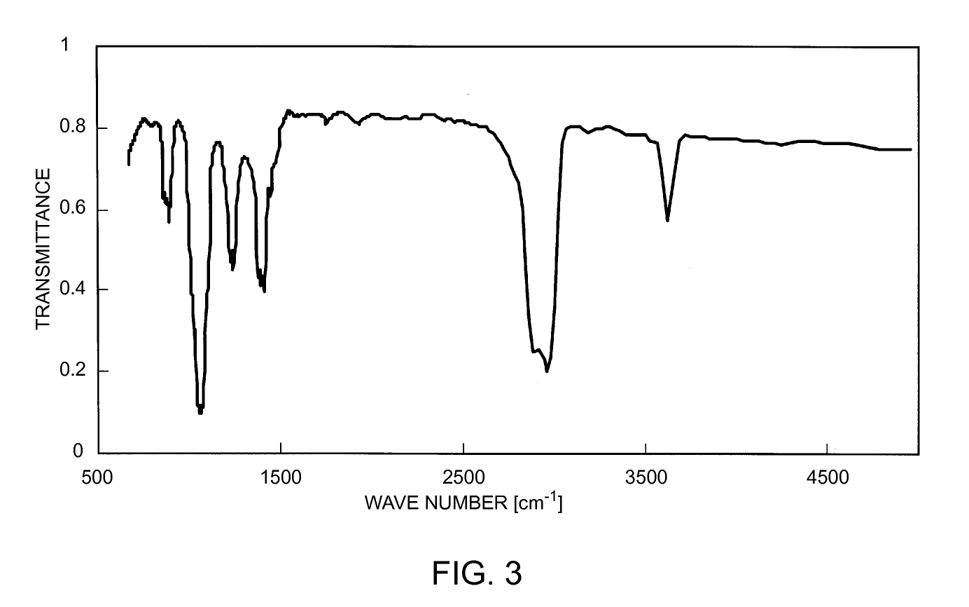

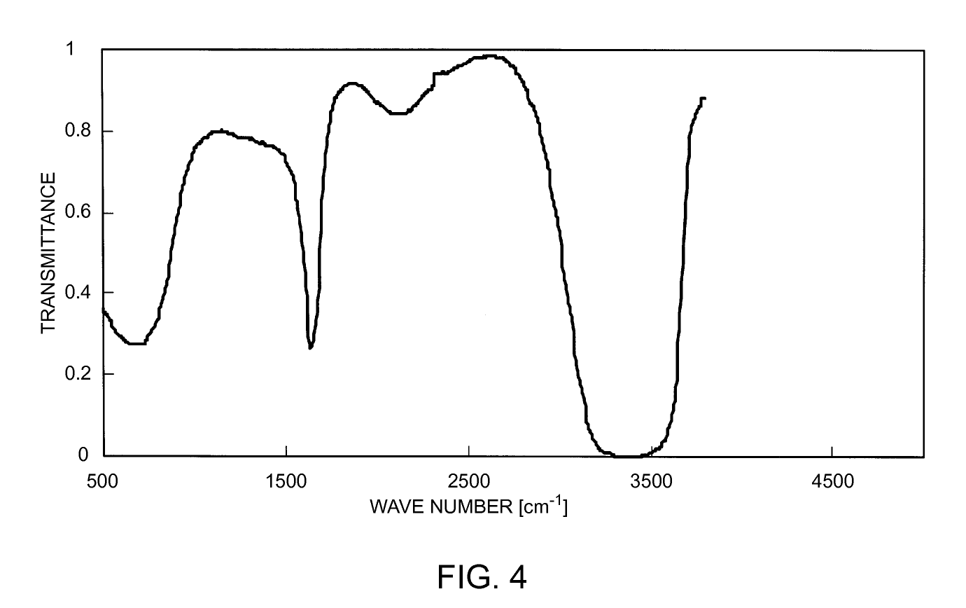

FIG. 3 shows the infrared absorption spectrum of ethanol (CH3-CH2-OH). FIG. 4 shows the infrared absorption spectrum of water (H2O). As clear from the comparison of FIGS. 2 to 4, the infrared rays of 1742 cm⁻¹ absorbed by acetone are transmitted through ethanol and water at a transmittance of 80% or higher and are scarcely absorbed. Therefore, as the infrared rays of 1742 cm⁻¹ become incident on a gas mixture of these three kinds of substances, necessary energy for desorption can be selectively given to acetone alone. Thus, it can be understood that a specific fluid molecule can be separated from a fluid mixture of three kinds of substances. Next, the absorptivity of the holding member 100 to infrared rays will be examined. As the holding member 100 used in this device, for example, a porous member that can hold the first fluid sample A can be suitably used as described above, irrespective of the quality of material and shape. The holding member 100 of this type may be, for example, one kind of substance or a mixture of two or more kinds of aluminum oxide group (bauxite, alumina, aluminum silicate), silicate (silica gel), activated carbons (bone charcoal, charcoal, coal), bentonite, white clay, diatomaceous earth group (Fuller's earth, bentonite, acid-treated clay, diatomaceous earth), hydrotalcite group (hydrotalcite) and ion-exchange resins (phenol formaldehyde resin, amine formaldehyde resin).

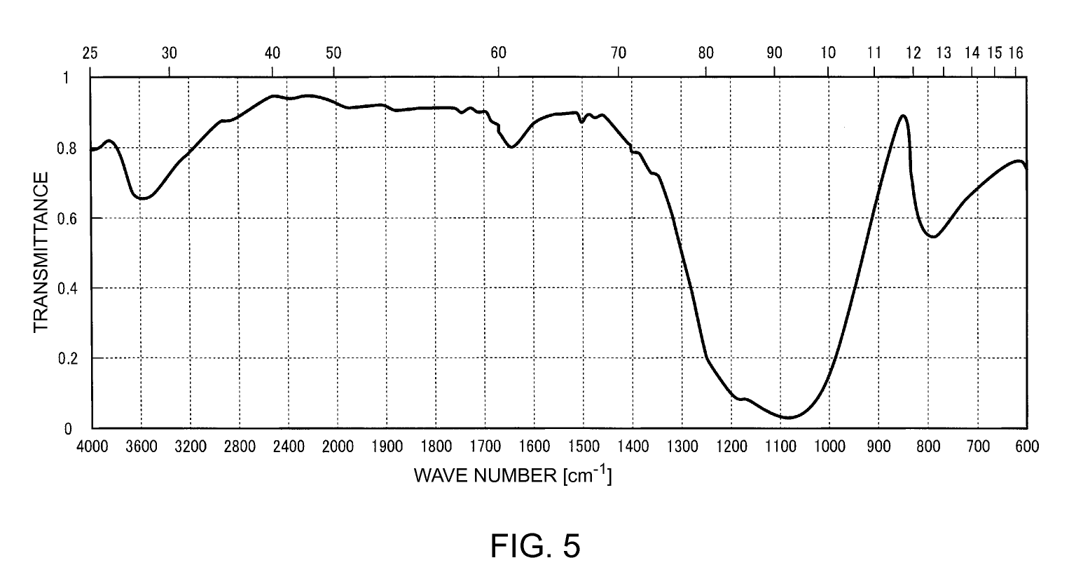

For example, aluminum silicate is an inorganic porous material and is used as an adsorbent of gas or the like. FIG. 5 shows the infrared absorption spectrum of aluminum silicate. It can be seen that aluminum silicate has a high transmittance to infrared rays of 2800 to 1700 cm⁻¹.

In this way, for example, when aluminum silicate is used as the holding member 100, the holding member 100 does not absorb infrared rays of 1742 cm⁻¹. Therefore, even when the light source 110 casts infrared rays of 1742 cm⁻¹ onto the holding member 100, the holding member 100 is not heated. That is, the holding member 100 does not transmit heat to other substances than the adsorbed separation target substance (in this example, acetone) and selectively gives energy only to the separation target substance, causing the separation target substance to be desorbed.

Based on FIGS. 2 to 5, the following can be understood. That is, when the first fluid sample A contains a specific substance (for example, acetone), an absorptivity L1 at which the specific substance absorbs light with a specific wavelength (for example, 1742 cm⁻¹) and an absorptivity L2 at which the other substances (for example, ethanol and water) in the first fluid sample than the specific substance absorb the light in the specific wavelength range satisfy L1>L2, and an absorptivity L3 at which the holding member absorbs the light in the specific wavelength range satisfies L3<L1.

Moreover, based on FIGS. 2 to 5, the absorptivity L1 at which the specific substance absorbs the light with the specific wavelength (for example, 1742 cm⁻¹) is L1>90% (see FIG. 2). The absorptivity L2 at which the other substances in the first fluid sample than the specific substance absorb the light in the specific wavelength range is L2>20% (see FIGS. 3 and 4). The absorptivity L3 at which the holding member absorbs the light in the specific wavelength range is L3<20% (see FIG. 5). Considering these, L1-L2≧60% and L1-L3≧60% hold, and more preferably L1-L2≧70% and L1-L3≧70% hold.

2.3. Light Source with Variable Emission Wavelength

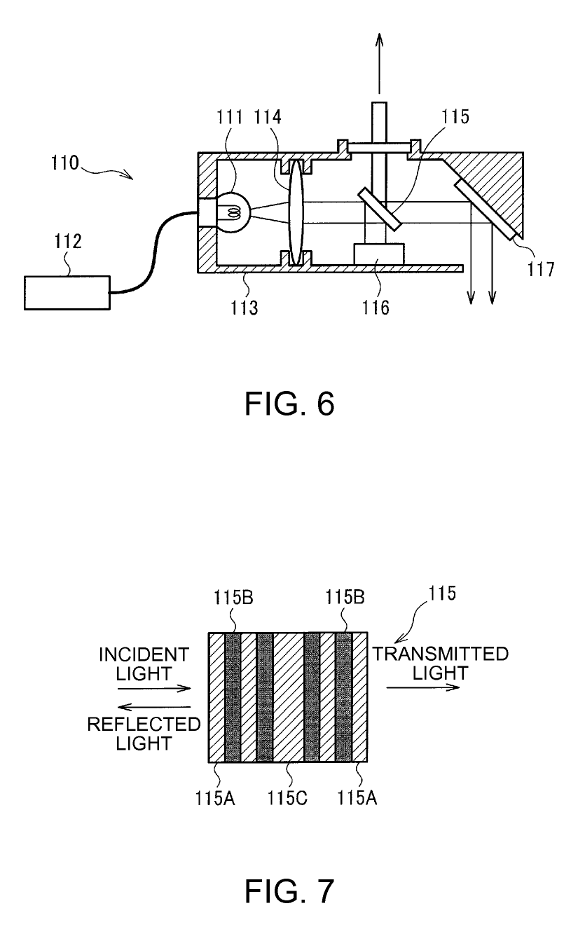

FIG. 6 shows the light source 110. As shown in FIG. 6, in the light source 110, a lamp which casts broad-range light including the wavelength absorbed by the separation target substance, for example, a carbon lamp 111 is connected to a power supply 112. In a casing 113 holding the lamp 111, a lens 114 for collimating exiting light, an optical filter 115, a beam damper 116 and a mirror 117 are held.

The optical filter 115 filters light to take out a wavelength that is absorbed by the separation target substance and is not absorbed by other substances than the separation target substance. The beam damper 116 intercepts the light reflected by the optical filter 115. The mirror 117 reflects the light filtering through the optical filter 115, toward the holding member 100.

As the optical filter 115, a band pass filter which passes a specific wavelength is used. To increase separation capability to a substance, it is desirable that only the wavelength absorbed by the separation target substance is passed. Therefore, it is desirable that the wavelength range to be passed is very narrow and that the half peak width thereof is 100 cm⁻¹ or less.

As an example of such optical filter 115, a Fabry-Perot filter can be employed. FIG. 7 shows an example of the structure of a Fabry-Perot filter. This optical filter 115 has a structure in which, between dielectric mirrors, each including two types of dielectric materials, that is, a high refractive index material 115A with a refractive index n₁ at an wavelength λ and a low refractive index material 115B with a refractive index n₂ stacked on each other to thicknesses λ/4n₁ and λ/4n₂, respectively, a defect layer of a material 115C with a refractive index n is provided to a thickness that is an integral multiple of λ/4n. This optical filter 115 has an acute, high transmittance peak at the wavelength λ.

This filter 115 is formed using a material that is transparent to the wavelength of infrared rays cast onto the light source 110, for example, silicon, germanium, aluminum oxide, quartz, zinc selenide, zinc sulfate, sodium chloride, potassium chloride, calcium fluoride, magnesium oxide, calcogenide glass or the like.

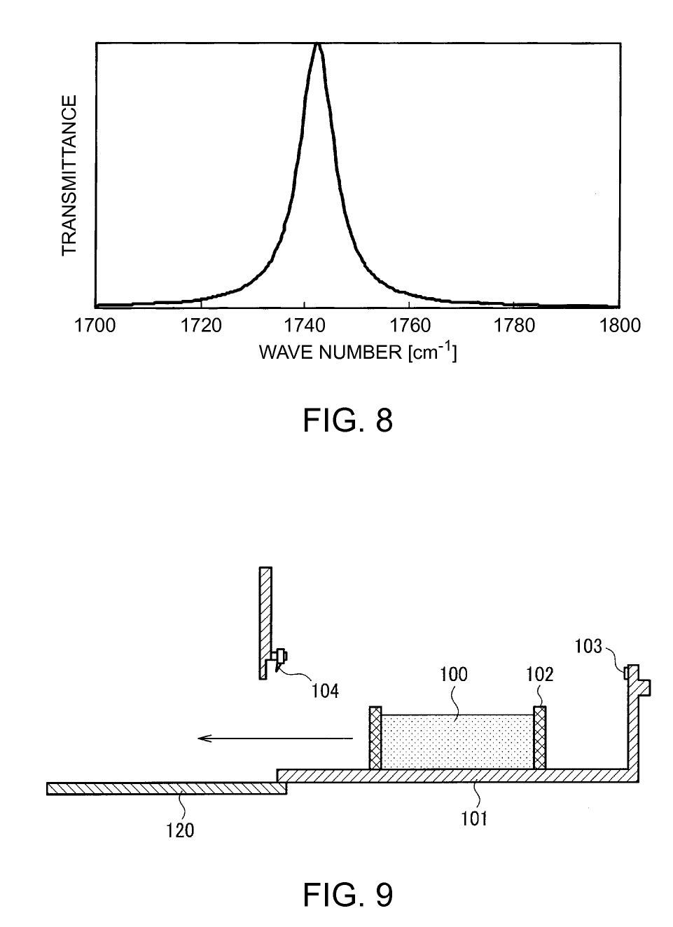

For example, a defect layer Ge with a thickness d=2n/λ is sandwiched between two dielectric mirrors, each including two pairs of germanium (Ge, with a refractive index n=1.723 at a wavelength 1742 cm⁻¹) and magnesium oxide (MgO, with a refractive index n=4.016 at a wavelength 1742 cm⁻¹) stacked alternately to a thickness d=4n/λ each. The optical filter 115 is thus formed. With this structure, FIG. 8 shows transmittance characteristics. In FIG. 8, the half value width of the transmitted wavelength range is 10 cm⁻¹ or less. The optical filter 115 can be removably attached to the chamber 120. Thus, when the separation target substance is changed, the optical filter 115 can be replaced so that the absorption peak of the separation target substance and the transmittance peak of the optical filter 115 coincide with each other. Alternatively, an optical filter that can vary the spectroscopic wavelength such as etalon may be employed.

### 2.4. Removable Holding Member

FIG. 9 shows the attachment mechanism of the holding member 100. On a slider 101 that can slide on the chamber 120, for example, a mesh-like basket 102 through which a fluid sample can pass is fixed and the holding member 100 is arranged in the basket 102. A sealant 103 is arranged at a portion where the slider 101 abuts on the chamber 120, and the slider 101 closes and becomes fixed by a retaining metal fitting 104, with the sealant 103 sandwiched between the slider 101 and the retaining metal fitting 104. Thus, the holding member 100 can be arranged in the chamber 120 in airtight state. Also, as the retaining metal fitting 104 is released, the slider 101 can be drawn out and the holding member 100 can be replaced.

### 3. Example of Principle and Structure of Photodetection

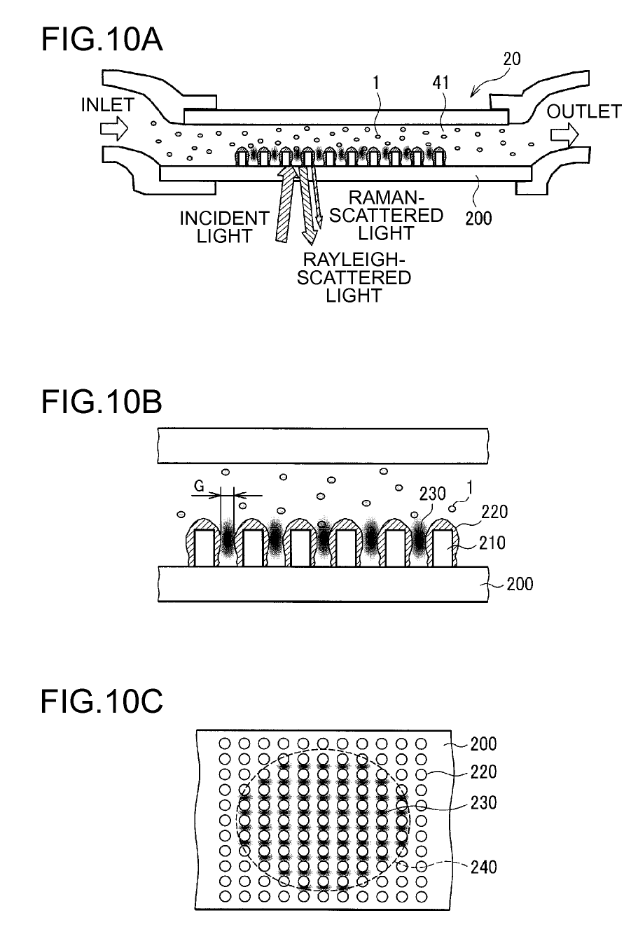

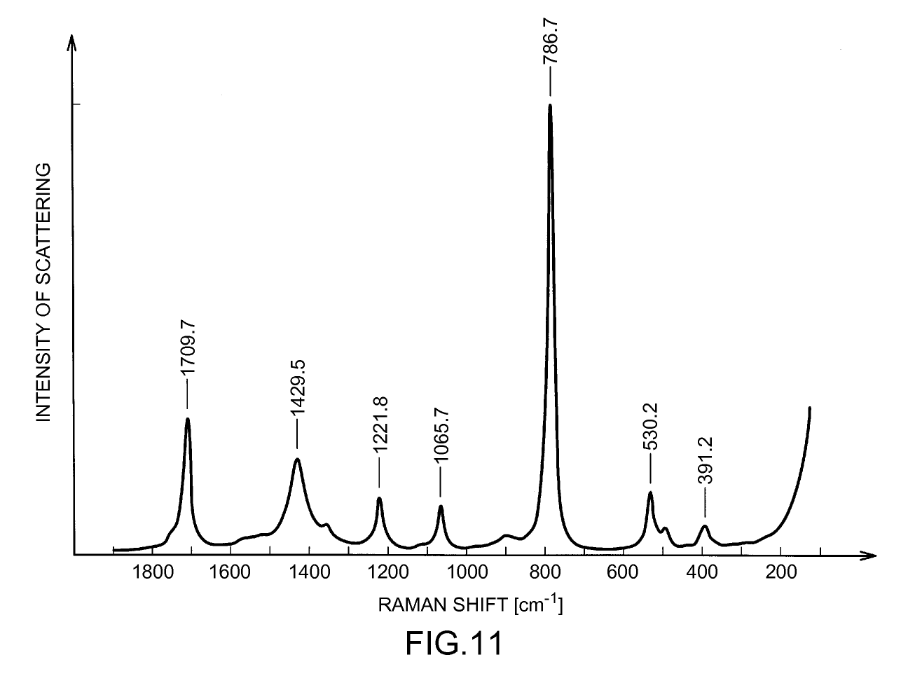

FIGS. 10A to 10C show explanatory views of the principle of detection of Raman-scattered light, as an example of the principle of photodetection which reflects a specific substance in the second fluid sample (fluid mixture) B created by the fluid separation device 12. As shown in FIG. 10A, incident light (with a number of vibrations ν) is cast onto a sample molecule 1 of a detection target in the second fluid sample B adsorbed to the optical device 20. Generally, most of the incident light is scattered as Rayleigh-scattered light and the number of vibrations ν or wavelength of the Rayleigh-scattered light does not change in relation to the incident light. A part of the incident light is scattered as Raman-scattered light and the number of vibrations ν′ of the sample molecule 1 (molecular vibration) is reflected in the number of vibrations (ν−ν′ and ν+ν′) or wavelength of the Raman-scattered light. That is, the Raman-scattered light is light which reflects the sample molecule 1 of a detection target. A part of the incident light causes the sample molecule 1 to vibrate and thus loses energy. However, the vibrational energy of the sample molecule 1 may be added to the vibrational energy or light energy of the Raman-scattered light. Such a shift (ν′) in the number of vibrations is called a Raman shift. FIG. 11 shows a Raman shift of acetone as an example of sample molecule.

FIG. 10B is an enlarged view of the optical device 20 of FIGS. 1 and 10A. In the case where incident light becomes incident from a flat surface of a substrate 200 as shown in FIG. 10A, a transparent material to the incident light is used for the substrate 200. The optical device 20 has plural protruding portions 210 made of a dielectric, as a first structure on the substrate 200. In this embodiment, a resist is formed on the substrate 200 made of quartz, crystal, glass such as bolosilicate glass, or silicon or the like as a transparent dielectric to the incident light. The resist is patterned, for example, using far ultraviolet (DUV) photolithography. As the substrate 200 is etched via the patterned resist, the plural protruding portions 210 are arranged two-dimensionally, for example, as shown in FIG. 10C. The substrate 200 and the protruding portions 210 may be made of different materials. As a second structure on the plural protruding portions 210, metal nanoparticles (metal particulates) 220 of, for example, Au or Ag or the like, are formed, for example, by evaporation, sputtering or the like. Consequently, the optical device 20 can have a metal nanostructure having protruding portions of 1 to 1000 nm. The metal nanostructure having protruding portions of 1 to 1000 nm can be formed by working a top surface of the substrate 200 so that protruding structures (of the substrate material) with the above size is provided, as well as by fixing metal particulates with the above size onto the substrate by evaporation, sputtering or the like, or by forming a metal film with island structures on the substrate and the like.

As shown in FIGS. 10B and 10C, in an area 240 where incident light becomes incident on the metal nanoparticles 220 formed in a two-dimensional pattern, an enhanced electric field 230 is formed in a gap G between neighboring metal nanoparticles 220. Particularly, when incident light is cast onto the metal nanoparticles 220 that are smaller than the wavelength of the incident light, the electric field of the incident light acts on free electrons existing on the surface of the metal nanoparticles 220 and causes resonance. Therefore, an electric dipole due to the free electrons is excited in the metal nanoparticles 220 and the enhanced electric field 230 that is more intense than the electric field of the incident light is formed. This is also called localized surface plasmon resonance (LSPR). This is a phenomenon peculiar to an electric conductor such as the metal nanoparticles 220 having protruding portions of 1 to 1000 nm smaller than the wavelength of the incident light.

In FIGS. 10A to 10C, surface enhanced Raman scattering (SERS) occurs when incident light is cast onto the optical device 20. That is, as the sample molecule 1 enters the enhanced electric field 230, Raman-scattered light due to this sample molecule 1 is enhanced by the enhanced electric field 230 and the signal intensity of the Raman-scattered light is increased. In such surface enhanced Raman scattering, detection sensitivity can be increased even with a minuscule quantity of the sample molecules 1.

A phenomenon of “adsorption” of the sample molecule 1 as described in the following surface enhanced Raman scattering is a phenomenon in which the number of colliding molecules (partial pressure) of the sample molecules 1 colliding with the metal nanoparticles 220 is dominant, and includes one or both of physical adsorption and chemical adsorption. “Desorption” means cancelation of adsorption by an external force. The adsorption energy depends on the kinetic energy of the sample molecule 1. When a certain value is exceeded, the molecule collides and presents the “adsorption” phenomenon. Adsorption requires no external force. Meanwhile, desorption requires an external force. Also, sucking the second fluid sample B to the optical device 20 is, to put it another way, generating a suction flow in the channel in which the optical device 20 is arranged, and causing the second fluid sample B to contact the optical device 20.

### 4. Specific Configuration of Detection Device

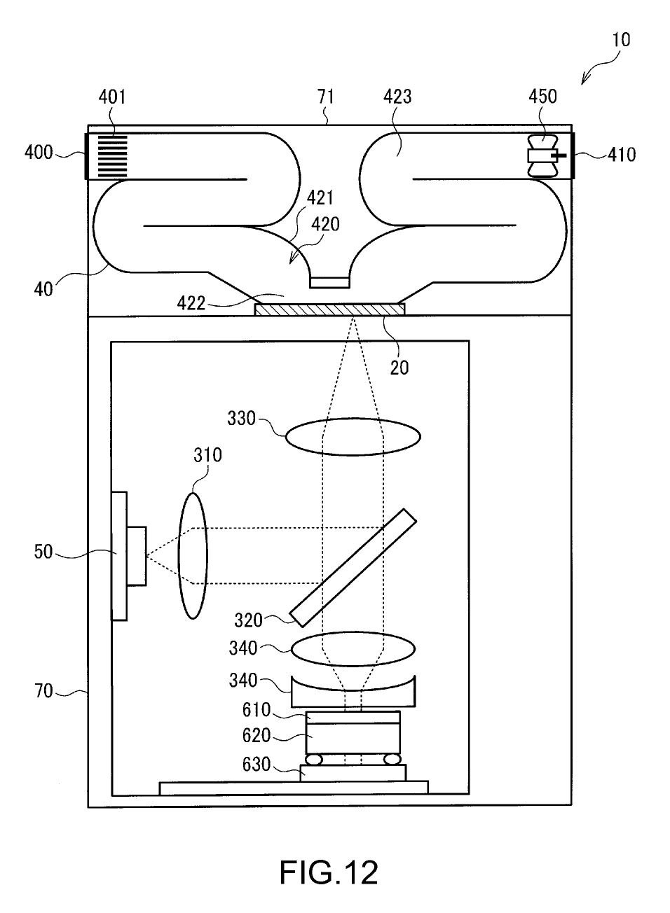

FIG. 12 shows a specific example of configuration of the detection device according to this embodiment. The detection device 10 shown in FIG. 12 includes the optical device 20, the optical system 30, the suction unit 40, the light source 50 and the photodetector unit 60 that are shown in FIG. 1.

In FIG. 12, the light source 50 is, for example, a laser and can preferably use a vertical cavity surface emitting laser in view of downsizing, though not limited to this.

Light from the light source 50 is converted into parallel light by a collimating lens 310 constituting the optical system 30. A polarization control element may be provided downstream of the collimating lens 310 and the light may be converted to a linearly polarized light. However, for example, when a surface emitting laser is employed as the light source 50, the polarization control element can be omitted as long as linearly polarized light can be emitted.

The light converted into parallel light by the collimating lens 310 is guided in the direction of the optical device 20 by a half mirror (dichroic mirror) 320, is then condensed by an objective lens 330, and becomes incident on the optical device 20. The metal nanoparticles 220 shown in FIGS. 10A to 10C are formed on the optical device 20. Rayleigh-scattered light and Raman-scattered light, for example, due to surface enhanced Raman scattering, are emitted from the optical device 20. The Rayleigh-scattered light and Raman-scattered light from the optical device 20 pass through the objective lens 330 and are guided in the direction of the photodetector unit 60 by the half mirror 320.

The Rayleigh-scattered light and Raman-scattered light from the optical device 20 are condensed by a condensing lens 340 and inputted to the photodetector unit 60. In the photodetector unit 60, first, these lights reach a light filter 610. The light filter 610 (for example, notch filter) takes out the Raman-scattered light. The Raman-scattered light further travels through a spectroscope 620 and is received by a light receiving element 630. The spectroscope 620 can be formed by, for example, an etalon or the like utilizing Fabry-Perot resonance, and can vary a wavelength range that can be passed. The wavelength of light passed through the spectroscope 620 can be controlled (selected) by a control unit (not shown). A Raman spectrum peculiar to the sample molecule 1 can be obtained by the light receiving element 630. By collating the obtained Raman spectrum with data that is held in advance the sample molecule 1 can be specified.

The suction unit 40 has a guiding unit 420 between a suction port 400 and a discharge port 410. The second fluid sample B containing the sample molecule 1 is introduced into the guiding unit 420 from the suction port 400 (inlet) and is discharged outside the guiding unit 420 from the discharge port 410. A dust filter 401 can be provided on the side of the suction port 400. In FIG. 12, the detection device 10 has the fan 450 near the discharge port 410. As the fan 450 is operated, the pressure (atmospheric pressure) in a suction channel 421 of the guiding unit 420, a channel 422 near the optical device 20 and a discharge channel 423 is reduced. Thus, the second fluid sample B together with the sample molecule 1 is sucked into the guiding unit 420. The second fluid sample B passes through the suction channel 421, travels through the channel 422 near the optical device 20, and is discharged from the discharge channel 423. In this process, a part of the sample molecule 1 is adsorbed to the surface (electric conductor) of the optical device 20.

As the sample molecule 1 which is a detection target substance, for example, sparse molecules of narcotic drugs, alcohol, residual pesticides and the like, or pathogens such as viruses can be considered. Particularly, this embodiment is suitable for real-time detection of these sample molecules 1.

The detection device 10 has the casing 70. Inside the casing 70, for example, the optical system 30, the light source 50 and the photodetector unit 60 are provided. Moreover, the detection device 10 has a cover 71. The cover 71 can accommodate the optical device 20 and the like.

The embodiment is described above in detail. However, those skilled in the art can easily understand that a number of modifications can be made without substantially departing from novel features of the invention and their effects.

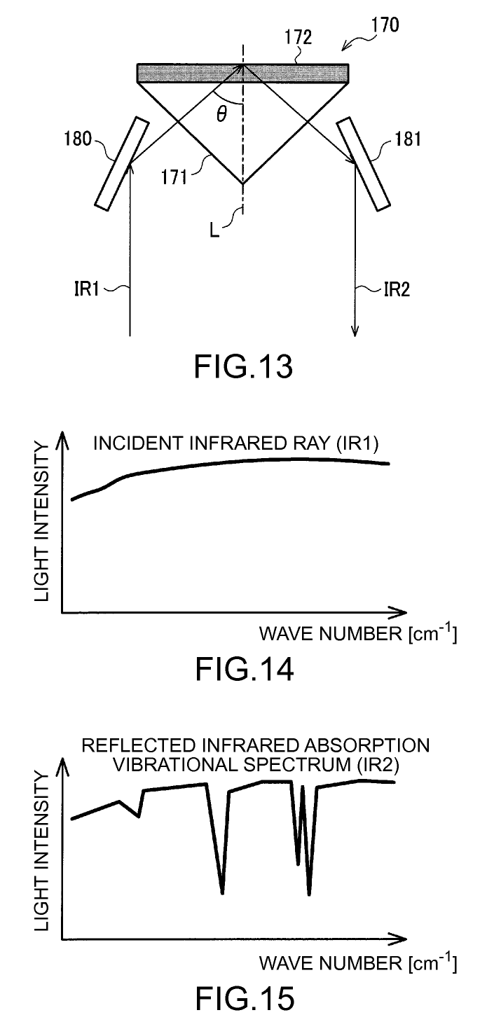

The detection device according to the invention is not limited to a detection which detects SERS intensity. For example, surface enhanced infrared absorption spectroscopy (SEIRAS) can be used. In this case, the optical device 20 shown in FIG. 12 is replaced with an optical device 170 shown in FIG. 13. This optical device 170 includes, for example, a metal thin film 172 formed on a bottom surface of a right-angle prism 171. The right-angle prism 171 is made of a material which transmits infrared rays, for example, CaF₂ or the like. The material of the metal thin film 172 may be Ag, Cu or the like.

A P-polarized infrared ray IR1 having a characteristic as shown in FIG. 14 is reflected, for example, by a first reflection mirror 180 and is made incident on the optical device 170 at an angle θ to a normal line L to the metal thin film 172. A reflected infrared ray IR2 obtained by total reflection of the incident infrared ray IR1 on the metal thin film 172 includes an evanescent wave that is reflected at a position slightly dug into toward the sample from the boundary. With the evanescent wave, the spectrum of the sample molecule and reference molecule can be measured. FIG. 15 shows a characteristic of the reflected infrared ray IR2. The reflected infrared ray IR2 is reflected by a second reflection mirror 181 and becomes incident on the photodetector unit 60 shown in FIG. 12 or the like.

The entire disclosure of Japanese Patent Application No. 2011-147094, filed Jul. 1, 2011 is expressly incorporated by reference herein.

What is claimed is:

1. A fluid separation device comprising:
a holding member which holds a first fluid sample; and
a light source which casts light with a specific wavelength onto the holding member;
wherein when the first fluid sample contains a specific substance, an absorptivity L1 at which the specific substance absorbs the light with the specific wavelength and an absorptivity L2 at which another substance in the first fluid sample than the specific substance absorbs the light with the specific wavelength satisfy L1>L2, and
an absorptivity L3 at which the holding member absorbs the light with the specific wavelength satisfies L3<L1.

2. The fluid separation device according to claim 1, wherein L1-L2≧60% and L1-L3≧60% hold.

3. The fluid separation device according to claim 1, wherein the light source has a variable emission wavelength.

4. The fluid separation device according to claim 1, further comprising:
a casing in which the holding member is accommodated;
an introduction port provided on the casing;
an exhaust port provided on the casing;
a channel connected to the casing;
a fan provided at least at one of the introduction port and the exhaust port; and
an open-close valve provided in each of the introduction port, the exhaust port and the channel.

5. A detection device comprising:
the fluid separation device according to claim 1 in which the first fluid sample is introduced and in which when the first fluid sample contains the specific substance, the specific substance is separated from the first fluid sample and a second fluid sample with an increased concentration of the specific substance is generated; and
a detection unit which detects the specific substance from the second fluid sample when the second fluid sample contains the specific substance.

6. A detection device comprising:
the fluid separation device according to claim 2 in which the first fluid sample is introduced and in which when the first fluid sample contains the specific substance, the specific substance is separated from the first fluid sample and a second fluid sample with an increased concentration of the specific substance is generated; and
a detection unit which detects the specific substance from the second fluid sample when the second fluid sample contains the specific substance.

7. A detection device comprising:
the fluid separation device according to claim 3 in which the first fluid sample is introduced and in which when the first fluid sample contains the specific substance, the specific substance is separated from the first fluid sample and a second fluid sample with an increased concentration of the specific substance is generated; and
a detection unit which detects the specific substance from the second fluid sample when the second fluid sample contains the specific substance.

8. A detection device comprising:
the fluid separation device according to claim 4 in which the first fluid sample is introduced and in which when the first fluid sample contains the specific substance, the specific substance is separated from the first fluid sample and a second fluid sample with an increased concentration of the specific substance is generated; and
a detection unit which detects the specific substance from the second fluid sample when the second fluid sample contains the specific substance.

9. A gas separation device comprising:
an adsorbent which adsorbs a first gas sample; and
a light source which casts light with a specific wavelength onto the adsorbent;
wherein when the first gas sample contains a specific substance, the light with the specific wavelength is cast onto the adsorbent from the light source, thereby raising a partial pressure of the specific substance in a second gas sample desorbed from the adsorbent above a partial pressure of the specific substance in the first gas sample.

10. A detection device comprising:
the gas separation device according to claim 9 in which the first gas sample is introduced and in which when the first gas sample contains the specific substance, the specific substance is separated from the first gas sample and the second gas sample with an increased partial pressure of the specific substance is generated; and
a detection unit which detects the specific substance from the second gas sample when the second gas sample contains the specific substance.

11. A detection device comprising:
a fluid separation device in which a first fluid sample is introduced and in which when the first fluid sample contains a specific substance, the specific substance is separated from the first fluid sample and a second fluid sample with an increased concentration of the specific substance is generated; and
a detection unit which detects the specific substance from the second fluid sample when the second fluid sample contains the specific substance;
wherein the fluid separation device includes
a holding member which holds the first fluid sample, and
a light source which has a variable emission wavelength and casts light with a wavelength which causes the specific substance to be desorbed from the holding member onto the holding member.
